(19) United States
(12) Patent Application Publication
(10) Pub. No.: US 2013/0282202 A1
(43) Pub. Date: Oct. 24, 2013

(54) VEHICLE CONTROL SYSTEM AND METHOD

(71) Applicant: YUH-SHYING GAU, Tu-Cheng (TW)

(72) Inventor: YUH-SHYING GAU, Tu-Cheng (TW)

(73) Assignee: HON HAI PRECISION INDUSTRY CO., LTD., Tu-Cheng (TW)

(21) Appl. No.: 13/450,757

(22) Filed: Apr. 19, 2012

(51) Int. Cl. G06F 7/00; G08G 1/00

(52) U.S. Cl. 701/2; 701/1; 701/117

(57) ABSTRACT

A vehicle control system is provided. The vehicle control system includes an observation module and a control profile determination module. The observation module is installed in a vehicle, which includes a location identification unit producing location information of the vehicle, and a control unit. The control profile determination module receives terrain information and weather information corresponding to the location information, determines a terrain condition type according to the terrain information, determines a weather condition type according to the weather information, and determines a suitable control profile according to the terrain condition type and the weather condition type. The control unit of the observation module adjusts control parameter(s) of the vehicle according to the suitable control profile. The disclosure further provides a vehicle control method and a non-transitory computer program for vehicle control.

### BACKGROUND

1. Technical Field

The present disclosure relates to a vehicle control system and a vehicle control method, and particularly to a vehicle control system and a vehicle control method automatically switching control profiles of a vehicle according to environmental conditions.

2. Description of Related Art

The horsepower provided by the engine of conventional vehicles is usually much greater than general usage demands. As a result, much horsepower is wasted since the effect of the engine cannot be optimized.

What is needed, therefore, is a vehicle control system capable of overcoming the limitations described.

### BRIEF DESCRIPTION OF THE DRAWINGS

Many aspects of the present disclosure can be better understood with reference to the drawings. The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIG. 1 is a block diagram of an embodiment of a vehicle control system of the present disclosure.

FIG. 2 is a schematic diagram of a map produced by the service cloud shown in FIG. 1.

FIG. 3 is a block diagram of another embodiment of a vehicle control system of the present disclosure.

FIG. 4 is a flowchart of an embodiment of a vehicle control method.

### DETAILED DESCRIPTION

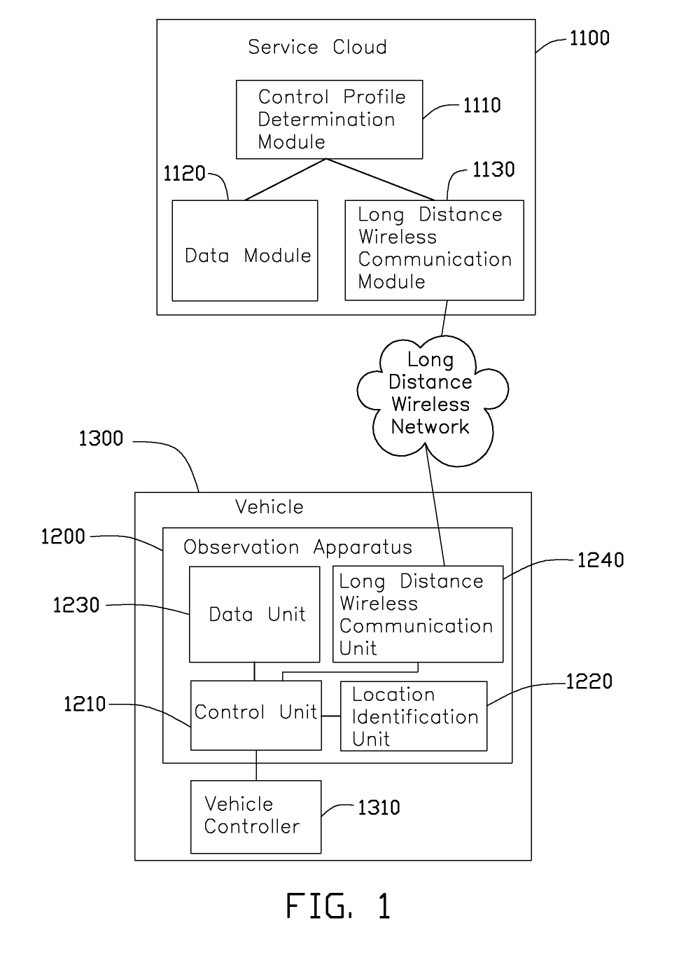

FIG. 1 is a block diagram of an embodiment of a vehicle control system of the present disclosure. The vehicle control system includes a service cloud 1100 and an observation apparatus 1200. The service cloud 1100 is composed of server(s), which includes a control profile determination module 1110, a data module 1120, and a long distance wireless communication module 1130. The observation apparatus 1200 is disposed in a vehicle 1300 such as a car or a motorcycle. In the illustrated embodiment, the vehicle 1300 includes a vehicle controller 1310 which may include an engine controller.

The observation apparatus 1200 includes a control unit 1210, a location identification unit 1220, a data unit 1230, and a long distance wireless communication unit 1240. In the illustrated embodiment, the location identification unit 1220 is a GPS (Global Positioning System) receiver which is capable of producing location information Il (not shown) representing a latitude, a longitude, and/or an elevation of a location of the vehicle 1300. In other embodiments, the location identification unit 1220 can be another type of location identification device such as Wi-Fi Positioning System (WPS) receiver, while the location information Il can include other type of locational data of the vehicle 1300. The data unit 1230 may include a high speed random access memory, a non-volatile memory, and/or other types of computer readable storage medium, which stores predetermined control profiles Pp (not shown). The predetermined control profile Pp includes parameter value(s) such as horsepower or torque which corresponds to control parameter(s) of the vehicle controller 1310 to be adjusted, which represents a driving mode such as an economy mode or a power mode. The parameter value(s) may conform to security standards for the vehicle 1300, which can be provided by a wireless service provider. The long distance wireless communication unit 1240 communicates with the long distance wireless communication module 1130 through a long distance wireless network implemented according to a telecommunication standard such as WI-FI or Global System for Mobile Communications (GSM).

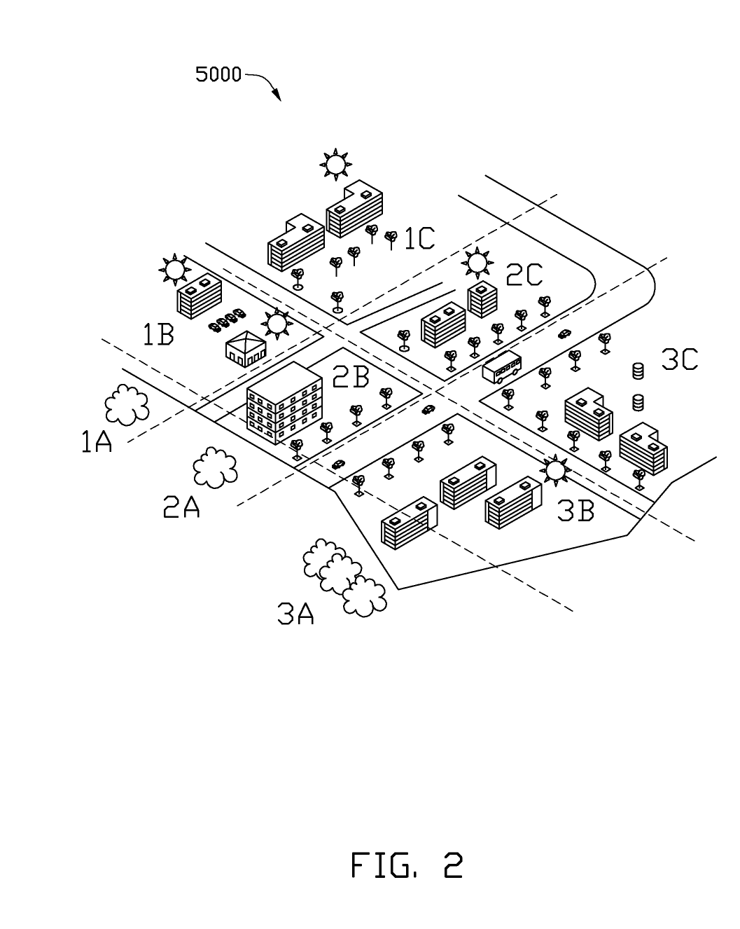

The observation apparatus 1200 is turned on when the engine of the vehicle 1300 is started. The observation apparatus 1200 tries to register to the service cloud 1100 after being turned on. After the observation apparatus 1200 registers, the service cloud 1100 requests the location information Il from the observation apparatus 1200. When the service cloud 1100 receives the location information Il, the control profile determination module 1110 of the service cloud 1100 receives terrain information, weather information, traffic information, and calendar information corresponding to the location information Il from, for example, third-party service providers or sensors connected to the service cloud 1100. The terrain information, the weather information, and the traffic information represent the terrain, the current traffic situation, and the weather at the location of the vehicle 1300, respectively. The calendar information includes daily activity information such as working hours, rush hours, workdays, or holidays with respect to the location of the vehicle 1300. FIG. 2 is a schematic diagram of a map 5000 produced by the service cloud shown in FIG. 1. In the illustrated embodiment, the service cloud 1100 produces the map 5000, which corresponds to the location of the vehicle 1300 according to the location information Il. The map 5000 is divided into portions 1A-1C, 2A-2C, and 3A-3C which correspond to areas of, for example, 1 square kilometer. The service cloud 1100 requests the location information Il from the observation apparatus 1200 when the vehicle 1300 moves across the locations corresponding to different portions of the map 5000.

The control profile determination module 1110 uses, for example, fuzzy logic theory, to determine a terrain condition type, a weather condition type, a traffic condition type, and a calendar condition type according to the terrain information, the weather information, the traffic information, and the calendar information, respectively. For instance, when the air temperature is 27 degrees centigrade and the relative humidity is 50 percents, the weather condition type is determined as sunny. Table 1 shows predetermined condition types defined in the vehicle control system. In the illustrated embodiment, predetermined terrain condition types, predetermined weather condition types, predetermined traffic condition types, and predetermined calendar condition types are defined, which are respectively divided into 3 levels, wherein the higher levels correspond to more severe conditions. Each of the predetermined control profiles Pp corresponds to a unique combination of one of the predetermined terrain condition types, one of the predetermined weather condition types, one of the predetermined traffic condition types, and one of the predetermined calendar condition types, for example, a combination of freeway terrain, sunny weather, good traffic, and holiday conditions.

TABLE 1

| Predetermined | | | |
|---|---|---|---|
| Condition Types | Level 1 | Level 2 | Level 3 |
| Terrain | Freeway | Highway | Rugged Path |
| Weather | Sunny | Cloudy | Rainy |
| Traffic | Good | Medium | Bad |
| Calendar | Holiday | Workday | Rush Hour |

The control profile determination module 1110 determines a suitable control profile Ps (not shown) according to the terrain condition type, the weather condition type, the traffic condition type, and the calendar condition type. The service cloud 1100 transmits the suitable control profile Ps to the observation apparatus 1200. In the illustrated embodiment, the suitable control profile Ps is a code corresponding to one of the predetermined control profiles Pp stored in the data unit 1230 of the observation apparatus 1200. In other embodiments, the suitable control profile Ps can include parameter value(s) which corresponds to the control parameter(s) of the vehicle controller 1310 of the vehicle 1300 to be adjusted, and the suitable control profile Ps is transmitted to the observation apparatus 1200, such that the observation apparatus 1200 can store the suitable control profile Ps in the data unit 1230.

The frequency of the control profile determination module 1110 of the service cloud 1100 to determine the suitable control profile Ps can be increased with increase in complexity of a terrain determined according to the terrain information, and decreased with decrease in complexity of the terrain by, changing the frequency of the service cloud 1100 to request the location information Il from the observation apparatus 1200 through, for example, changing the manner of the map 5000 to be divided. The map 5000 can be divided into smaller portions when the complexity of the terrain increases, and is divided into larger portions when the complexity of the terrain decreases. For instance, if the terrain of an area is mountainous, the control profile determination module 1110 increases the frequency to determine the suitable control profile Ps with respect to the area by dividing the portion of the map 5000 corresponding to the area into smaller portions which correspond to an area of, for example, 0.2 square kilometer.

In response to receiving the suitable control profile Ps, the control unit 1210 of the observation apparatus 1200 adjusts the control parameter(s) of the vehicle controller 1310 of the vehicle 1300 according to the parameter value(s) in the predetermined control profile Pp corresponding to the suitable control profile Ps. In the illustrated embodiment, the predetermined control profile Pp used in a location corresponding to each location information Il is stored in the data unit 1230 as a used control profile record. When the observation apparatus 1200 does not receive the suitable control profile Ps for the location of the vehicle 1300 in a predetermined period such as 1 minute after the location information Il is transmitted, the control unit 1230 adjusts the control parameter(s) of the vehicle controller 1310 of the vehicle 1300 according to the predetermined control profile Pp corresponding to the used control profile record for the location. In addition, the data unit 1230 stores a standard control profile for normal driving mode. When the observation apparatus 1200 does not receive the suitable control profile Ps for the location of the vehicle 1300 in a predetermined period after the location information Il is transmitted, and the used control profile record for the location is not found in the data unit 1230, the control unit 1210 adjusts the control parameter(s) of the vehicle controller 1310 of the vehicle 1300 according to the standard control profile.

Table 2 shows weights and value ranges of the value of the condition types defined in the vehicle control system. In the illustrated embodiment, the value of the terrain condition type, the weather condition type, the traffic condition type, and the calendar condition type have a terrain condition weight, a weather condition weight, a traffic condition weight, and a calendar condition weight, respectively. The terrain condition weight and the weather condition weight are larger than the traffic condition weight and the calendar condition weight. The levels of each of the condition types correspond to different values in the value range of the condition type, wherein the higher levels correspond to higher values. For instance, the level 1, the level 2, and the level 3 of the terrain condition type correspond to values of 3, 6, and 10, respectively. Each of the predetermined control profiles Pp has a required weighted value, wherein the predetermined control profiles Pp with greater required weighted value correspond to higher safety demands. The predetermined control profiles Pp with smaller required weighted value correspond to higher energy conservation demands. The control profile determination module 1110 determines the suitable control profile Ps by choosing one of the predetermined control profiles Pp having the minimum required weighted value equal to or smaller than a sum of the weighted value of the terrain condition type, the weather condition type, the traffic condition type, and the calendar condition type, wherein the weighted value is obtained by multiplying the value of the corresponding calendar condition type by the weight of the corresponding calendar condition type.

TABLE 2

| Condition Types | Weights | Value Ranges |
|---|---|---|
| Terrain | 5 | 1~10 |
| Weather | 5 | 1~10 |
| Traffic | −1 | 1~5 |
| Calendar | −1 | 1~3 |

In other embodiments, the control profile determination module 1110 can determine the suitable control profile Ps further according to other condition types, for example, a vehicle condition type which represents the status of the vehicle 1300. Correspondingly, the control profile determination module 1110 further receives vehicle status information from the vehicle 1300 through the observation apparatus 1200, and determines the vehicle condition type according to the vehicle status information. Furthermore, the control profile determination module 1110 can determine the suitable control profile Ps merely according to the terrain condition type and the weather condition type. Correspondingly, the control profile determination module 1110 merely receives the terrain information and the weather information corresponding to the location information Il when receiving the location information Il, and determines the terrain condition type and the weather condition type according to the terrain information and the weather information, respectively.

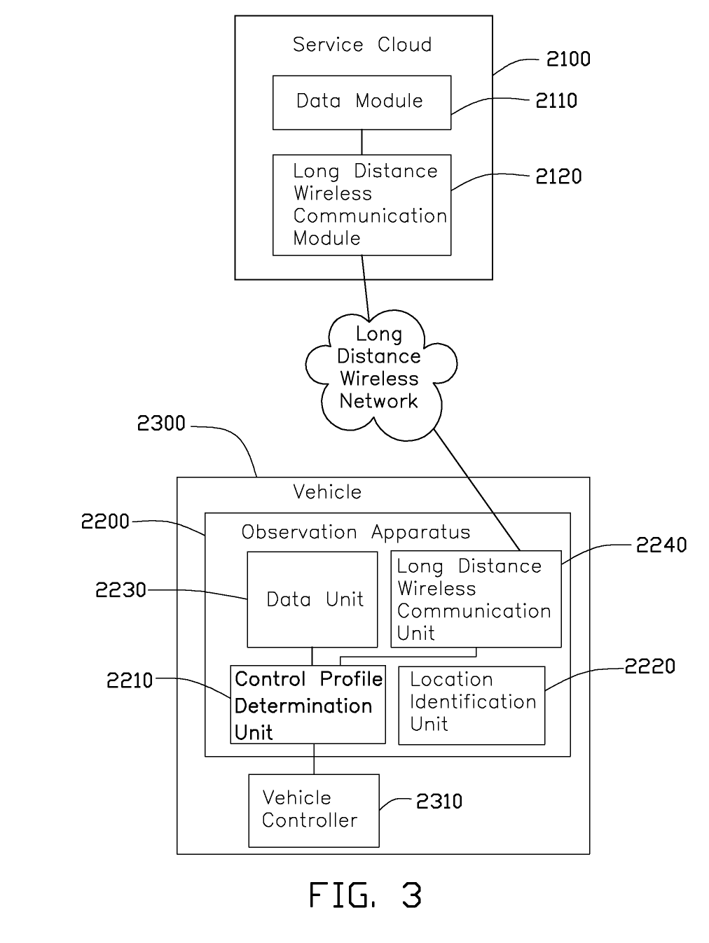

FIG. 3 is a block diagram of another embodiment of a vehicle control system of the present disclosure. The vehicle control system includes a service cloud 2100 and an observation apparatus 2200 disposed in a vehicle 2300 including a vehicle controller 2310. The service cloud 2100 includes a data module 2110 and a long distance wireless communication module 2120. The observation apparatus 2200 includes a control profile determination unit 2210, a location identification unit 2220, a data unit 2230, and a long distance wireless communication unit 2240. The location identification unit 2220 is capable of producing the location information Il of a location of the vehicle 2300. The data unit 2230 stores the predetermined control profile(s) Pp. The predetermined control profile Pp includes the parameter value(s), which corresponds to control parameter(s) of the vehicle controller 2310 of the vehicle 2300 to be adjusted, and essential conditions in choosing the predetermined control profiles Pp. The long distance wireless communication unit 2240 communicates with the long distance wireless communication module 2120 of the service cloud 2100 through a long distance wireless network.

The control profile determination unit 2210 receives the terrain information, the weather information, the traffic information, and the calendar information corresponding to the location information Il from the service cloud 2100 and/or, for example, sensors connected to the observation apparatus 2200. The control profile determination unit 2210 further determines the terrain condition type, the weather condition type, the traffic condition type, and the calendar condition type according to the terrain information, the weather information, the traffic information, and the calendar information, respectively, and determines the suitable control profile Ps according to the terrain condition type, the weather condition type, the traffic condition type, and the calendar condition type. In the illustrated embodiment, the suitable control profile Ps is determined by choosing one of the predetermined control profile Pp having the essential conditions corresponding to the terrain condition type, the weather condition type, the traffic condition type, and the calendar condition type, such that the control parameter(s) of the vehicle controller 2310 of the vehicle 2300 can be adjusted according to the parameter value(s) in the predetermined control profile Pp.

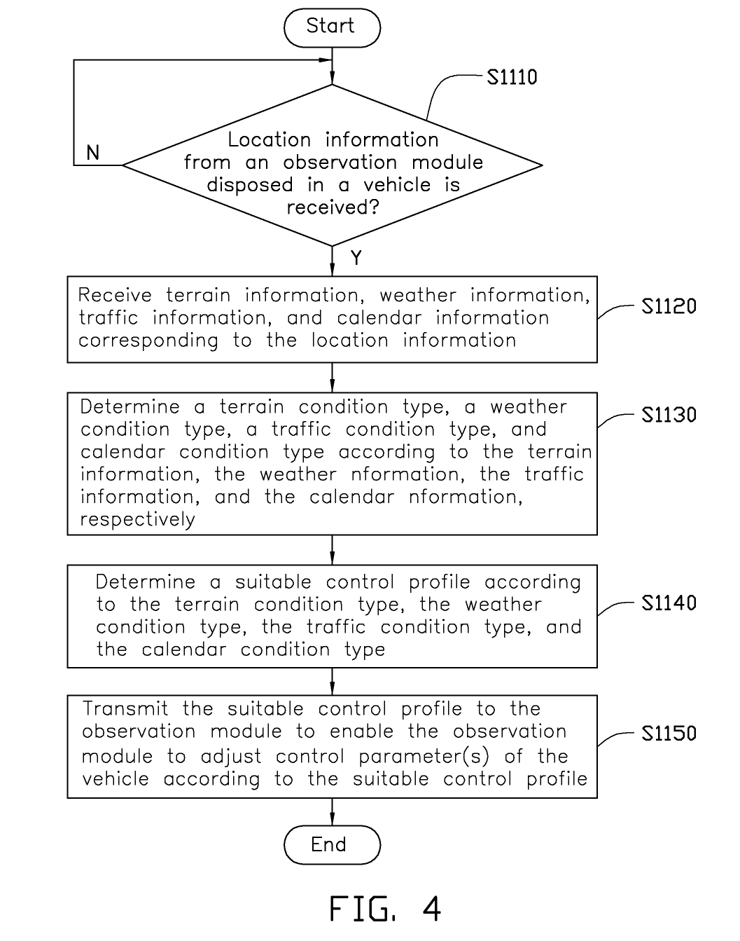

FIG. 4 is a flowchart of an embodiment of a vehicle control method. The vehicle control method of the present disclosure follows. Depending on the embodiment, additional steps may be added, others removed, and the ordering of the steps may be changed.

In step S1110, a determination is made as to whether location information from an observation module disposed in a vehicle is received. If yes, step S1120 is implemented; otherwise, step S1110 is repeated.

In step S1120, terrain information, weather information, traffic information, and calendar information corresponding to the location information is received.

In step S1130, a terrain condition type, a weather condition type, a traffic condition type, and a calendar condition type is determined according to the terrain information, the weather information, the traffic information, and the calendar information, respectively. In the illustrated embodiment, fuzzy logic theory is used to determine the condition types.

In step S1140, a suitable control profile is determined according to the terrain condition type, the weather condition type, the traffic condition type, and the calendar condition type. In the illustrated embodiment, the value of each of the terrain condition type, the weather condition type, the traffic condition type, and the calendar condition type have a weight, the weight of the terrain condition type and the weather condition type are higher than the weight of the traffic condition type and the calendar condition type. The suitable control profile is determined by choosing one of a plurality of predetermined control profiles which has a minimum required weighted value equal to or smaller than a sum of the weighted value of the terrain condition type, the weather condition type, the traffic condition type, and the calendar condition type.

In step S1150, the suitable control profile is transmitted to the observation module, such that the observation module can adjust control parameter(s) of the vehicle according to the suitable control profile. In the illustrated embodiment, the control parameter(s) of the vehicle is adjusted according to one of the predetermined control profiles corresponding to the suitable control profile, wherein the predetermined control profile is pre-stored in a computer readable storage medium.

In the embodiment, the predetermined control profile used in a location corresponding to each of the location information is stored in a computer readable storage medium as a used control profile record. When the observation module does not receive the suitable control profile for the location of the vehicle in a predetermined period after the location information is transmitted, the observation module adjusts the control parameter(s) of the vehicle according to the predetermined control profile corresponding to the used control profile record for the location. In addition, a standard control profile can be stored in the computer readable storage medium. When the observation module does not receive the suitable control profile for the location of the vehicle in a predetermined period after the location information is transmitted, and the used control profile record for the location is not found, the observation module adjusts the control parameter(s) of the vehicle according to the standard control profile.

The vehicular vehicle control system and the vehicular vehicle control method are capable of switching control profiles of a vehicle according to environmental conditions. Consequently, the effect of the engine of the vehicle is optimized, and power can be saved. In addition, the comfort for the driver of the vehicle is increased.

While the disclosure has been described by way of example and in terms of preferred embodiment, the disclosure is not limited thereto. On the contrary, it is intended to cover various modifications and similar arrangements as would be apparent to those skilled in the art. Therefore the range of the appended claims should be accorded the broadest interpretation so as to encompass all such modifications and similar arrangements.

What is claimed is:

1. A vehicle control system, comprising:
an observation module disposed in a vehicle, comprising:
a location identification unit producing location information of the vehicle; and
a control unit adjusting one or more control parameters of the vehicle according to a suitable control profile; and
a control profile determination module, wherein the control profile determination module receives terrain information and weather information corresponding to the location information, determines a terrain condition type according to the terrain information, determines a weather condition type according to the weather information, and determines the suitable control profile according to the terrain condition type and the weather condition type.

2. The vehicle control system of claim 1, wherein the control profile determination module receives traffic information corresponding to the location information, determines a traffic condition type according to traffic information, and determines the suitable control profile according to the traffic condition type.

3. The vehicle control system of claim 1, wherein the control profile determination module uses fuzzy logic theory to determine the terrain condition type and the weather condition type.

4. The vehicle control system of claim 1, wherein the data unit stores a standard control profile, when the observation module does not receive the suitable control profile in a predetermined period, the control unit of the observation module adjusts the one or more control parameters of the vehicle according to the standard control profile.

5. The vehicle control system of claim 1, wherein the observation module comprises a data unit storing a plurality of predetermined control profiles, the suitable control profile corresponds to one of the predetermined control profiles, the control unit of the observation module adjusts the one or more control parameters of the vehicle according to the predetermined control profile corresponding to the suitable control profile.

6. The vehicle control system of claim 5, wherein the predetermined control profile used in a location corresponding to each of the location information is recorded in the data unit as a used control profile record, when the observation module does not receive the suitable control profile for the location in a predetermined period, the control unit adjusts the one or more control parameters of the vehicle according to the predetermined control profile corresponding to the used control profile record for the location.

7. The vehicle control system of claim 5, wherein the control profile determination module determines a traffic condition type according to traffic information, and determines the suitable control profile according to the traffic condition type, each of the value of the terrain condition type, the weather condition type, and the traffic condition type has a weight, the weighs of the terrain condition type and the weather condition type are higher than the weigh of the traffic condition type, each of the predetermined control profiles has a required weighted value, the control profile determination module of the one or more servers determines the suitable control profile by choosing one of the predetermined control profiles having the minimum required weighted value equal to or smaller than a sum of the weighted value of the terrain condition type, the weather condition type, and the traffic condition type.

8. The vehicle control system of claim 5, wherein the terrain condition type corresponds to one of a plurality of predetermined terrain condition types, the weather condition type corresponds to one of a plurality of predetermined weather condition types, each of the predetermined control profiles corresponds to a unique combination of one of the predetermined terrain condition types and one of the predetermined weather condition types.

9. The vehicle control system of claim 1, wherein the terrain condition type corresponds to one of a plurality of predetermined terrain condition types, the weather condition type corresponds to one of a plurality of predetermined weather condition types.

10. The vehicle control system of claim 1, wherein the observation module further comprises a long distance wireless communication unit, the vehicle control system further comprising:
one or more servers, comprising:
the control profile determination module; and
a long distance wireless communication module communicating with the observation module through the long distance wireless communication unit of the observation module;
wherein the one or more servers transmit the suitable control profile to the observation module to enable the observation module to adjust the one or more control parameters of the vehicle according to the suitable control profile.

11. The vehicle control system of claim 1, wherein the control profile determination module is disposed in the observation module.

12. The vehicle control system of claim 1, wherein the frequency of the control profile determination module of the one or more servers to determine the suitable control profile increases with increase in complexity of a terrain determined according to the location information and decreases with decrease in complexity of the terrain.

13. An vehicle control method, comprising:
receiving location information from an observation module disposed in a vehicle;
receiving terrain information and weather information corresponding to the location information;
determining a terrain condition type according to the terrain information;
determining a weather condition type according to the weather information;
determining a suitable control profile according to the terrain condition type and the weather condition type; and
transmitting the suitable control profile to the observation module to enable the observation module to adjust one or more of control parameters of the vehicle according to the suitable control profile.

14. The vehicle control method of claim 13, further comprising:
receiving traffic information corresponding to the location information; and
determining a traffic condition type according to the traffic information;
wherein the step of determining the suitable control profile comprises:
determining the suitable control profile according to the terrain condition type, the weather condition type, and the traffic condition type.

15. The vehicle control method of claim 13, wherein the step of determining the terrain condition type comprises:
using fuzzy logic theory to determine the terrain condition type according to the terrain information; and
the step of determining the weather condition type comprises:
using fuzzy logic theory to determine the weather condition type according to the weather information.

16. The vehicle control method of claim 13, wherein when the observation module does not receive the suitable control profile in a predetermined period, the step of adjusting the one or more control parameters of the vehicle comprises:
adjusting the one or more control parameters of the vehicle according to a standard control profile.

17. The vehicle control method of claim 13, wherein the step of transmitting the suitable control profile comprises:
adjusting the one or more control parameters of the vehicle according to one of a plurality of predetermined control profiles corresponding to the suitable control profile.

18. The vehicle control method of claim 17, further comprising:
recording the predetermined control profile used in a location corresponding to each of the location information as a used control profile record; and
when the suitable control profile for the location is not received in a predetermined period:
adjusting the one or more control parameters of the vehicle according to the control profile corresponding to the used control profile record for the location.

19. The vehicle control method of claim 17, wherein each of the value of the terrain condition type, the weather condition type, and the traffic condition type has a weight, the weighs of the terrain condition type and the weather condition type are higher than the weigh of the traffic condition type, each of the predetermined control profiles has a required weighted value, the method further comprising:
receiving traffic information corresponding to the location information; and
determining a traffic condition type according to the traffic information;
wherein the step of determining the suitable control profile comprises:
choosing one of the predetermined control profiles having the minimum required weighted value equal to or smaller than a sum of the weighted value of the terrain condition type, the weather condition type, and the traffic condition type.

20. A non-transitory computer program comprising a computer readable storage medium and an executable computer program mechanism embedded therein, the executable computer program mechanism comprising instructions for:
receiving location information from an observation module disposed in a vehicle;
receiving terrain information and weather information corresponding to the location information;
determining a terrain condition type according to the terrain information;
determining a weather condition type according to the weather information;
determining a suitable control profile according to the terrain condition type and the weather condition type; and
transmitting the suitable control profile to the observation module to enable the observation module to adjust one or more of control parameters of the vehicle according to the suitable control profile.
